(19) United States
(12) Patent Application Publication
(10) Pub. No.: US 2023/0064814 A1
(43) Pub. Date: Mar. 2, 2023

(54) METHOD FOR MANUFACTURING AN OPTICAL FIBRE AND OPTICAL FIBER THEREOF

(71) Applicant: Sterlite Technologies Limited, Gurgaon (IN)

(72) Inventors: Badri Gomatam, Gurgaon (IN); Nivedita Prasad, Gurgaon (IN); Chandan Saha, Gurgaon (IN)

(21) Appl. No.: 17/553,537

(22) Filed: Dec. 16, 2021

(30) Foreign Application Priority Data
Aug. 27, 2021 (EP) 20748282.9

(51) Int. Cl. C03B 15/14; G02B 6/028; G02B 6/44

(52) U.S. Cl. CPC C03B 15/14; G02B 6/0285; G02B 6/4479; C03B 2201/12

(57) ABSTRACT

A method for manufacturing an optical fibre includes placing the powdery substance compactly in the fluorine doped tube to form a core section. The core section of the glass preform is defined along a longitudinal axis of the glass preform. In particular, the fluorine doped tube is sintered to solidify the powdery substance. Moreover, the glass preform is heated at high temperature to draw the optical fibre.

### FIELD OF THE INVENTION

Embodiments of the present invention relate to the field of glass manufacturing, in particular, the present disclosure relates to a method for manufacturing an optical fibre and the optical fibre produced thereof.

### BACKGROUND

Optical fibre communication has revolutionized the telecommunication industry in the past few years. The use of optical fibre cables has helped to bridge the gap between distant places around the world. One of the basic components of the optical fibre cable is an optical fibre. The optical fibre is responsible for carrying vast amounts of information from one place to another. There are different methods for manufacturing glass bodies and optical fibres. These methods are primarily adopted to manufacture glass preform or glass preform. Few such methods employed for manufacturing optical fibres are powder-in-tube technique, rod-in-cylinder technique, vapor deposition techniques and the like. However, the currently available optical fibres have high attenuation losses.

The powder-in-tube technique involves a powdery material which is placed inside a tube and then sintered to form a glass preform. Accordingly, the optical fibre is drawn from the glass preform using conventional drawing methods. However, the conventional technique does not result in complete utilization of glass preform and does not result in fabrication of continuous fibres. Also, the conventional method leads to air gaps in the glass preform which leads to fibre breaks and bubbles in the fibre produced. In addition, the fibre breaks and bubbles result in losses in the fibre.

Thus in light of the above stated discussion, there is a need to develop an optical fibre preform with extremely low attenuation loss that overcomes the above stated disadvantages and provides ease in manufacturing.

### SUMMARY OF THE INVENTION

Embodiments of the present invention relates to a method for manufacturing an optical fibre from a glass preform comprising steps of placing a powdery substance compactly inside a fluorine doped tube, sintering the fluorine doped tube filled with the powdery substance, and drawing the optical fibre from the glass preform. In particular, the powdery substance is used to form a core section of the glass preform. Moreover, the fluorine doped tube forms a cladding section of the glass preform. Furthermore, the powdery substance solidifies and adheres smoothly with the fluorine doped tube to form the glass preform. Additionally, the glass preform is heated at high temperature to draw the optical fibre.

In accordance with an embodiment of the present invention, the powdery substance forms a core section of the glass preform and a fluorine doped tube forms a cladding section of the glass preform.

In accordance with an embodiment of the present invention, a refractive index of the core section is greater than the refractive index of the cladding section.

In accordance with an embodiment of the present invention, the powdery substance corresponds to Calcium Aluminium Silicate (CAS) powder.

In accordance with an embodiment of the present invention, the powdery substance has size in a range of about 30 microns to 50 microns.

In accordance with an embodiment of the present invention, the fluorine doped tube is of hollow cylindrical shape.

In accordance with an embodiment of the present invention, the fluorine doped tube has a diameter of about 44 millimeter.

In accordance with an embodiment of the present invention, the fluorine doped tube is sintered at temperature in a range of about 1500 degree Celsius to 1600 degree Celsius.

In accordance with an embodiment of the present invention, the method comprises heating of glass preform inside a furnace at high temperature to draw the optical fibre.

In accordance with an embodiment of the present invention, the method is a powder-in-tube technique.

In accordance with an embodiment of the present invention, an optical fibre drawn from a glass preform comprising a core section of the glass preform defined as a region around the longitudinal axis and a cladding section of the glass preform circumferentially surrounds the core section. In particular, the core section extends radially outward from the longitudinal axis of the optical fibre preform.

The foregoing objectives of the present invention are attained by employing an ultra low loss optical fibre and a method of manufacture thereof.

### BRIEF DESCRIPTION OF THE DRAWINGS

So that the manner in which the above recited features of the present invention is understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A is a pictorial representation illustrating an overview of a glass preform in accordance with an embodiment of the present invention;

FIG. 1B is a block diagram illustrating the optical fibre in accordance with an embodiment of the present invention;

FIG. 2 is a flow chart illustrating a method to manufacture a glass preform for drawing an optical fibre in accordance with one embodiment of the present invention.

### ELEMENT LIST

Glass preform—100
Longitudinal axis—102
Fluorine doped tube—104
Powdery substance—106

The method and the reduced diameter optical fibre preform are illustrated in the accompanying drawings, throughout which like reference letters indicate corresponding parts in the various figures. It should be noted that the accompanying figure is intended to present illustrations of exemplary embodiments of the present invention. This figure is not intended to limit the scope of the present invention. It should also be noted that the accompanying figure is not necessarily drawn to scale.

### DETAILED DESCRIPTION OF THE INVENTION

The present invention relates to an ultra low loss optical fibre and a method of manufacture thereof.

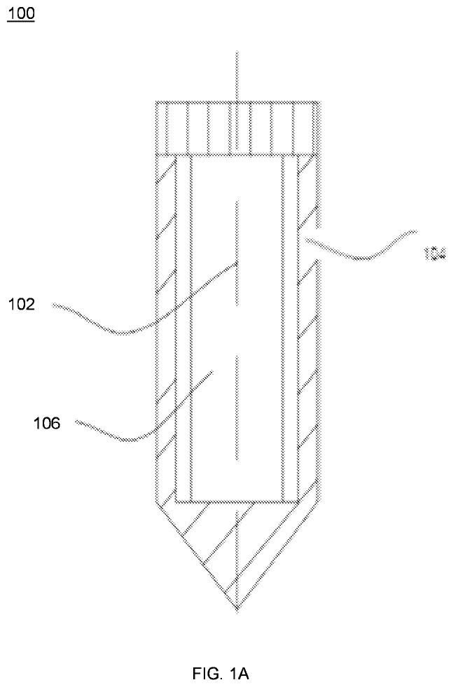

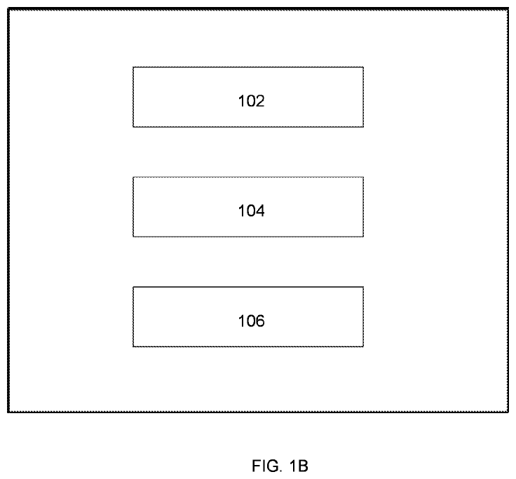

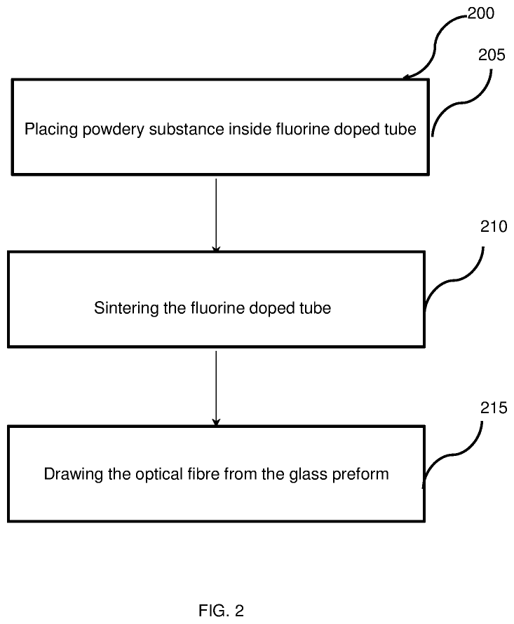

The principles of the present invention and their advantages are best understood by referring to FIG. 1A to FIG. 2. In the following detailed description numerous specific details are set forth in order to provide a thorough understanding of the embodiment of invention as illustrative or exemplary embodiments of the invention, specific embodiments in which the invention may be practiced are described in sufficient detail to enable those skilled in the art to practice the disclosed embodiments. However, it will be obvious to a person skilled in the art that the embodiments of the invention may be practiced with or without these specific details. In other instances, well known methods, procedures and components have not been described in detail so as not to unnecessarily obscure aspects of the embodiments of the invention.

The following detailed description is, therefore, not to be taken in a limiting sense, and the scope of the present invention is defined by the appended claims and equivalents thereof. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. References within the specification to “one embodiment,” “an embodiment,” “embodiments,” or “one or more embodiments” are intended to indicate that a particular feature, structure, or characteristic described in connection with the embodiment is included in at least one embodiment of the present invention.

Although the terms first, second, etc. may be used herein to describe various elements, these elements should not be limited by these terms. These terms are generally only used to distinguish one element from another and do not denote any order, ranking, quantity, or importance, but rather are used to distinguish one element from another. Further, the terms “a” and “an” herein do not denote a limitation of quantity, but rather denote the presence of at least one of the referenced items.

Conditional language used herein, such as, among others, “can,” “may,” “might,” “may,” “e.g.,” and the like, unless specifically stated otherwise, or otherwise understood within the context as used, is generally intended to convey that certain embodiments include, while other embodiments do not include, certain features, elements and/or steps.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

The Following Brief Definition of Terms Shall Apply Throughout the Present Invention:

Optical fibre is used for transmitting information as light pulses from one end to another. In addition, optical fibre is a thin strand of glass or plastic capable of transmitting optical signals. Further, optical fibre allows transmission of information in the form of optical signals over long distances. Furthermore, optical fibre is used for a variety of purposes. The variety of purposes includes telecommunications, broadband communications, medical applications, military applications and the like.

Refractive index of a material is the ratio of speed of light in vacuum to speed of light in material.

In general, glass is a non-crystalline amorphous solid, often transparent and has widespread applications. In addition, the applications of glass ranges from practical usage in daily life, technological usage, and decorative usage. Further, most common type of glass is silicate glass formed of chemical compound silica.

Referring to FIGS. 1A and 1B, illustrating a glass preform 100 in accordance with an embodiment of the present invention. In general, preform is a large cylindrical body of glass having a core structure and a cladding structure. And, preform is a material used for fabrication of optical fibres. In particular, the glass preform 100 is associated with a longitudinal axis 102. The longitudinal axis 102 is an imaginary axis passing through the geometrical centre of the glass preform 100.

The glass preform 100 includes a core section and a cladding section. The core section is an inner part of the glass preform 100 or an optical fibre and the cladding section is an outer part of the glass preform 100 or the optical fibre. Moreover, the core section and the cladding section are formed during manufacturing stage of the glass preform 100. Further, the core section is defined as a region around the longitudinal axis 102 of the glass preform 100. The core section extends radially outward from the longitudinal axis 102 of the glass preform 100.

In accordance with an embodiment of the present invention, the core section of the glass preform is made from the powdery substance 106. The powdery substance 106 is utilized to form the core section of the glass preform. The powdery substance corresponds to a Calcium Aluminium Silicate (CAS) powder. The Calcium Aluminium Silicate is obtained in various forms such as molten, glass or powder that is casted as glass or directly used for making the core and the cladding of the optical fibre.

In accordance with an embodiment of the present invention, the core section has a refractive index that is greater than a refractive index of the cladding section. The refractive index is maintained as per a desired level based on a concentration of chemicals used for the production of the glass preform 100.

In accordance with an embodiment of the present invention, the Calcium Aluminium Silicate (CAS) powder has a size in a range of about 30 microns-50 microns. Alternatively, the Calcium Aluminium Silicate (CAS) powder of any suitable size may be used. Particularly, the size of 30 microns-50 microns of the Calcium Aluminium Silicate (CAS) enables high flow ability and prevents sticking of the Calcium Aluminium Silicate (CAS) powder particles.

In accordance with an embodiment of the present invention, the fluorine doped tube 104 has a diameter of about 44 millimetres. Alternatively, the fluorine doped tube 104 may have any suitable diameter.

In accordance with an embodiment of the present invention, the glass preform 100 has a diameter of about 44 millimetres. Alternatively, the glass preform 100 may have any suitable value of diameter.

In an embodiment of the present disclosure, the fluorine doped tube 104 is sintered at a temperature in a range of about 1500 degree Celsius to 1600 degree Celsius. Alternatively, the sintering temperature may vary.

In accordance with an embodiment of the present invention, the glass preform 100 has reduced dimensions. The glass preform 100 has high draw ability characteristics. The optical fibre produced from the glass preform 100 is an ultra-low loss optical fibre. The optical fibre produced is free of breaks and bubbles. Also, the sintering leads to homogeneity which accounts for longer length of fibres. The optical fibre produced has low attenuation, low bending losses and the like which results in higher transmission of data.

FIG. 2 is a flow chart illustrating a method to manufacture a glass preform for drawing an optical fibre. Method 200 starts at step 205, and proceeds to steps 210, and 215.

At step 205, the Calcium Aluminium Silicate (CAS) powder is placed inside the fluorine doped tube 104. Particularly, the fluorine doped tube 104 is filled with the Calcium Aluminium Silicate powder. In addition, the fluorine doped tube 104 with the Calcium Aluminium Silicate powder is processed to form the glass preform 100.

At step 210, the fluorine doped tube 104 filled with the Calcium Aluminium Silicate (CAS) powder is sintered. The Calcium Aluminium Silicate (CAS) powder after sintering becomes consolidated glass and adheres smoothly with the fluorine doped tube 104 to form the glass preform 100.

At step 215, the optical fibre is drawn from the glass preform. Particularly, the glass preform (100) is heated at high temperature to draw the optical fibre.

In accordance with an embodiment of the present invention, the fluorine doped tube 104 with the Calcium Aluminium Silicate powder is processed by any suitable method of the like. In addition, the glass preform 100 is processed through conventional fibre drawing process. The fibre drawing process involves high temperature heating of the glass preform 100 formed from the above stated method. The glass preform 100 may be heated inside a furnace at high temperature such that the glass preform 100 collapses into an optical fibre.

In accordance with an embodiment of the present invention, the ultra-low loss glass preform is manufactured to produce an ultra-low loss optical fibre through conventional drawing methods. The method utilizes a powder-in-tube technique for manufacturing the glass preform 100. The method enables the continuous process for manufacturing the glass preform 100 from raw material. In particular, the method has a plurality of components collectively enabling continuous manufacturing of the glass preform 100. The method manufactures the glass preform 100 with high material utilization. In addition, the method manufactures the glass preform 100 of various sizes. Further, the method manufactures the glass preform 100 of various shapes. Further, the method manufactures the glass preform 100 of various lengths. Moreover, the method allows manufacturing of the glass preform 100 in reduced time.

In accordance with an embodiment of the present invention, the method manufactures the glass preform 100 of any suitable shape, size and length. In another embodiment of the present disclosure, the method manufactures the glass preform 100 of any suitable form of the like.

In accordance with an embodiment of the present invention, the glass preform 100 is manufactured by a plurality of manufacturing techniques. The plurality of manufacturing techniques includes a powder-in-tube technique. The powder-in-tube technique involves use of a fluorine doped tube 104 and a powdery substance 106. The powdery substance 106 is used to form the core of the optical fibre and is inserted inside the fluorine doped tube 104. In addition, the fluorine doped tube 104 is sintered at a high temperature to form the glass preform 100. The fluorine doped tube 104 is a cylindrical shaped tube. In an embodiment of the present disclosure, the fluorine doped tube 104 may have any other suitable shape.

The present invention provides a method for manufacturing a glass preform and an ultra-low loss optical fibre produced from the glass preform with better material utilization, no air gaps, no breaks and bubbles and high draw ability.

The foregoing descriptions of pre-defined embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

What is claimed for:

1. A method for manufacturing an optical fibre from a glass preform comprising steps of:
placing a powdery substance compactly inside a fluorine doped tube, wherein the powdery substance is used to form a core section of the glass preform, wherein the fluorine doped tube forms a cladding section of the glass preform,
sintering the fluorine doped tube filled with the powdery substance, wherein the powdery substance solidifies and adheres smoothly with the fluorine doped tube to form the glass preform; and
drawing the optical fibre from the glass preform, wherein the glass preform is heated at high temperature to draw the optical fibre.

2. The method of manufacturing as claimed in claim 1, wherein the powdery substance forms a core section of the glass preform and a fluorine doped tube forms a cladding section of the glass preform.

3. The method of manufacturing as claimed in claim 1, wherein the powdery substance corresponds to Calcium Aluminium Silicate (CAS) powder.

4. The method of manufacturing as claimed in claim 2, wherein the powdery substance has size in a range of about 30 microns to 50 microns.

5. The method of manufacturing as claimed in claim 1, wherein the fluorine doped tube has diameter of about 44 millimeter.

6. The method of manufacturing as claimed in claim 1, wherein the fluorine doped tube is sintered at temperature in a range of about 1500 degree Celsius to 1600 degree Celsius.

7. The method of manufacturing as claimed in claim 1, wherein the fluorine doped tube is of hollow cylindrical shape.

8. The method of manufacturing as claimed in claim 1, wherein the method comprises heating of glass preform inside a furnace at high temperature to draw the optical fibre.

9. The method of manufacturing as claimed in claim 1, wherein the method is a powder-in-tube technique.

10. The method of manufacturing as claimed in claim 1, wherein a refractive index of the core section is greater than the refractive index of the cladding section.

11. An optical fibre drawn from a glass preform comprising:
a core section of the glass preform defined as a region around the longitudinal axis; wherein the core section extends radially outward from the longitudinal axis of the optical fibre preform
a cladding section of the glass preform circumferentially surrounds the core section.

12. The optical fibre as claimed in claim 11, wherein the core section formed by a powdery substance.

13. The optical fibre as claimed in claim 11, wherein the cladding section is formed by a fluorine doped tube.

14. The optical fibre as claimed in claim 12, wherein the powdery substance corresponds to Calcium Aluminium Silicate (CAS) powder.

15. The optical fibre as claimed in claim 14, wherein the powdery substance has size in a range of about 30 microns to 50 microns.

16. The optical fibre as claimed in claim 13, wherein the fluorine doped tube has diameter of about 44 millimeter.

17. The optical fibre as claimed in claim 16, wherein the fluorine doped tube is sintered at temperature in range of about 1500 degree Celsius to 1600 degree Celsius.

18. The optical fibre as claimed in claim 17, wherein the fluorine doped tube is of hollow cylindrical shape.

19. The optical fibre as claimed in claim 11, wherein the glass preform is heated inside a furnace at high temperature to draw the optical fibre.

20. The optical fibre as claimed in claim 11, wherein a refractive index of the core section is greater than the refractive index of the cladding section.
